(19) United States
(12) Patent Application Publication
(10) Pub. No.: US 2026/0331046 A1
(43) Pub. Date: Oct. 22, 2026

(54) DATA PROVIDING CIRCUIT, DISPLAY SUBSTRATE, PANEL, DRIVING METHOD, AND DISPLAY DEVICE

(71) Applicants: Beijing BOE Technology Development Co., Ltd., Beijing (CN); BOE TECHNOLOGY GROUP CO., LTD., Beijing (CN)

(72) Inventors: Xiaorong CUI, Beijing (CN); Li XIAO, Beijing (CN); Haoliang ZHENG, Beijing (CN); Dongni LIU, Beijing (CN); Jiao ZHAO, Beijing (CN); Yuzhen GUO, Beijing (CN); Minghua XUAN, Beijing (CN); Chenyang ZHANG, Beijing (CN); Lipeng GAO, Beijing (CN)

(21) Appl. No.: 18/995,087

(22) PCT Filed: Sep. 27, 2023
(86) PCT No.: PCT/CN2023/122100

§ 371 Date: Jan. 15, 2025

(51) Int. Cl. G09G 3/3233

(52) U.S. Cl. CPC G09G 3/3233; G09G 2300/0426; G09G 2300/0465; G09G 2300/0819; G09G 2300/0852; G09G 2310/0297; G09G 2310/08

(57) ABSTRACT

The present disclosure provides a data providing circuit, a display substrate, a panel, a driving method, and a display device. The data providing circuit includes a multiplexing circuit and a reset circuit; N is an integer greater than 1; the multiplexing circuit writes a data voltage into an n-th data line under control of an n-th multiplexing control signal; n is a positive integer less than or equal to N; the reset circuit controls an initial voltage to be written into data lines other than a first data line in N data lines under control of a first multiplexing control signal.

### CROSS-REFERENCE TO RELATED APPLICATION

This application is the U.S. national phase of PCT Application No. PCT/CN2023/122100 filed on Sep. 27, 2023, which is incorporated in its entirety by reference herein for all purposes.

### TECHNICAL FIELD

The present disclosure relates to the field of display technologies, and particularly to a data providing circuit, a display substrate, a panel, a driving method, and a display device.

### BACKGROUND

In the related technologies, mainstream light-emitting diode (LED) backplanes depend on splicing process to increase size, so it is needed to compress signal lines within the layout so as to realize seamless splicing. The quantity of data lines affects the width of the splice joint, thus time division multiplexing is generally adopted to reduce the quantity of data lines. Time division multiplexing is also commonly used to reduce the quantity of data voltage providing terminals of source electrode drivers in high PPI (pixel circuit) display.

### SUMMARY

In an aspect, embodiments of the present disclosure provide a data providing circuit, including a multiplexing circuit and a reset circuit, where N is an integer greater than 1;
the multiplexing circuit is electrically connected to a data voltage providing terminal, N multiplexing control terminals, and N data lines, and is configured to write a data voltage provided by the data voltage providing terminal into an n-th data line under control of an n-th multiplexing control signal provided by an n-th multiplexing control terminal; n is a positive integer less than or equal to N;
the reset circuit is electrically connected to a first multiplexing control terminal, an initial voltage line, and data lines other than a first data line in the N data lines, and is configured to control an initial voltage provided by the initial voltage line to be written into the data lines other than the first data line in the N data lines under control of a first multiplexing control signal provided by the first multiplexing control terminal.

Optionally, the reset circuit includes M reset sub-circuits; M is equal to N−1; m is a positive integer less than or equal to M;
a control terminal of an m-th reset sub-circuit is electrically connected to the first multiplexing control terminal, a first terminal of the m-th reset sub-circuit is electrically connected to the initial voltage line, and a second terminal of the m-th reset sub-circuit is electrically connected to an (m+1)-th data line;
the m-th reset sub-circuit is configured to write the initial voltage provided by the initial voltage line into the (m+1)-th data line under control of the first multiplexing control signal provided by the first multiplexing control terminal.

Optionally, the multiplexing circuit includes N multiplexing sub-circuits;
a control terminal of an n-th multiplexing sub-circuit is electrically connected to the n-th multiplexing control terminal, a first terminal of the n-th multiplexing sub-circuit is electrically connected to the data voltage providing terminal, and a second terminal of the n-th multiplexing sub-circuit is electrically connected to the n-th data line;
the n-th multiplexing sub-circuit is configured to write the data voltage provided by the data voltage providing terminal into the n-th data line under control of the n-th multiplexing control signal provided by the n-th multiplexing control terminal.

In a second aspect, embodiments of the present disclosure provide a display substrate, including a base and the above-mentioned data providing circuit provided on the base.

Optionally, the reset circuit in the data providing circuit includes M reset sub-circuits; M is equal to N−1; m is a positive integer less than or equal to M;
a control terminal of an m-th reset sub-circuit is electrically connected to the first multiplexing control terminal, a first terminal of the m-th reset sub-circuit is electrically connected to the initial voltage line, and a second terminal of the m-th reset sub-circuit is electrically connected to an (m+1)-th data line; the m-th reset sub-circuit is configured to write the initial voltage provided by the initial voltage line into the (m+1)-th data line under control of the first multiplexing control signal provided by the first multiplexing control terminal;
a first terminal of a reset sub-circuit in the M reset sub-circuits is further used as a first terminal of another reset sub-circuit in the M multiplexing sub-circuits.

Optionally, the multiplexing circuit in the data providing circuit includes N multiplexing sub-circuits;
a control terminal of an n-th multiplexing sub-circuit is electrically connected to the n-th multiplexing control terminal, a first terminal of the n-th multiplexing sub-circuit is electrically connected to the data voltage providing terminal, and a second terminal of the n-th multiplexing sub-circuit is electrically connected to the n-th data line; the n-th multiplexing sub-circuit is configured to write the data voltage provided by the data voltage providing terminal into the n-th data line under control of the n-th multiplexing control signal provided by the n-th multiplexing control terminal;
the second terminal of the n-th multiplexing sub-circuit is further used as a second terminal of an (n−1)-th reset sub-circuit.

Optionally, the m-th reset sub-circuit includes an m-th reset transistor;
a gate electrode of the m-th reset transistor is electrically connected to the first multiplexing control terminal, a first electrode of the m-th reset transistor is electrically connected to the initial voltage line, and a second electrode of the m-th reset transistor is electrically connected to the (m+1)-th data line;
a first electrode of a reset transistor in M reset transistors is further used as a first electrode of another reset transistor in the M multiplexing transistors.

Optionally, the n-th multiplexing sub-circuit includes an n-th multiplexing transistor;
a gate electrode of the n-th multiplexing transistor is electrically connected to the n-th multiplexing control terminal, a first electrode of the n-th multiplexing transistor is electrically connected to the data voltage providing terminal, and a second electrode of the n-th multiplexing transistor is electrically connected to the n-th data line;
the second electrode of the n-th multiplexing transistor is further used as a second electrode of an (n−1)-th reset transistor.

Optionally, N is equal to 3, and M is equal to 2;
a first electrode of a first reset transistor is further used as a first electrode of a second reset transistor;
the first electrode of the first reset transistor is further used as a second electrode of a second multiplexing transistor, and a second electrode of the second reset transistor is further used as a second electrode of a third multiplexing transistor.

Optionally, N is equal to 5, and M is equal to 4;
a first electrode of a first reset transistor is further used as a first electrode of a second reset transistor, and a first electrode of a third reset transistor is further used as a first electrode of a fourth reset transistor;
the first electrode of the first reset transistor is further used as a second electrode of a second multiplexing transistor, and a second electrode of the second reset transistor is further used as a second electrode of a third multiplexing transistor; the first electrode of the third reset transistor is further used as a second electrode of a fourth multiplexing transistor, and a second electrode of the fourth reset transistor is further used as a second electrode of a fifth multiplexing transistor.

In a third aspect, embodiments of the present disclosure provide a display panel, including the above-mentioned display substrate.

In a fourth aspect, embodiments of the present disclosure provide a display panel, including the above-mentioned data providing circuit.

Optionally, the display panel according to at least one embodiment of the present disclosure further includes pixel circuits arranged in multiple rows and columns in a display region;
the pixel circuit includes a light-emitting element, a drive circuit, and a writing control circuit;
the drive circuit is configured to generate a drive current for driving the light-emitting element under control of a potential of a control terminal of the drive circuit;
the writing control circuit is electrically connected to a scanning line, the data line, and a first terminal of the drive circuit, and is configured to write a data voltage provided by the data line into the first terminal of the drive circuit under control of a scanning signal provided by the scanning line.

In a fifth aspect, embodiments of the present disclosure provide a driving method, applied to the above-mentioned display panel, where the display cycle includes a data writing stage, and the data writing stage includes N writing time periods;
the driving method includes:
controlling, by the reset circuit, the initial voltage provided by the initial voltage line to be written into the data lines other than the first data line in the N data lines under control of the first multiplexing control signal, during a first writing time period; and
writing, by the multiplexing circuit, the data voltage provided by the data voltage providing terminal into the n-th data line under control of the n-th multiplexing control signal, during an n-th writing time period;
where N is an integer greater than 1, and n is a positive integer less than or equal to N.

Optionally, the display panel further includes pixel circuits arranged in multiple rows and columns in a display region; the pixel circuit includes a light-emitting element, a drive circuit, and a writing control circuit; the driving method further includes:
writing, by the writing control circuit, a data voltage provided by the data line into a first terminal of the drive circuit under control of a scanning signal, in the data writing stage.

Optionally, a start of the data writing stage coincides with a start of the first writing time period.

Optionally, the display cycle further includes a pre-writing stage; the pre-writing stage is before the data writing stage, and the pre-writing stage is immediately adjacent to the data writing stage; the driving method includes:
in the pre-writing stage, controlling, by the reset circuit, the initial voltage provided by the initial voltage line to be written into the data lines other than the first data line in the N data lines under control of the first multiplexing control signal, and writing, by the multiplexing circuit, the data voltage provided by the data voltage providing terminal into the first data line under control of the first multiplexing control signal.

Optionally, the driving method according to at least one embodiment of the present disclosure further includes:
controlling the data voltage provided by the data voltage providing terminal to be Va+ΔVa during an a-th writing time period, where a is an integer less than or equal to N and greater than 1;
where ΔVa is equal to (Va−Vth−V0)−(e^{-(t1-t0a)/RC})−e^{-(t1/RC)}),
where Vth is a threshold voltage of a drive transistor included in the drive circuit, and Va is a data voltage required to be written into an a-th data line during the a-th writing time period;
t1 is a duration of the data writing stage, and t0a is equal to (a−1)−(t2+t3),
where t2 is a duration of each writing time period, t3 is an interval time between two adjacent writing time periods, R is a resistance value of a resistor on the data line, C is a capacitance value of a coupling capacitor on the data line, and V0 is a voltage on the data lines after the reset circuit controls the initial voltage provided by the initial voltage line to be written into the data lines other than the first data line in the N data lines under control of the first multiplexing control signal.

In a sixth aspect, embodiments of the present disclosure provide a display device, including the above-mentioned display panel.

### BRIEF DESCRIPTION OF THE DRAWINGS

FIG. 1 is a structural diagram of a related data providing circuit;

FIG. 2 is a circuit diagram of at least one embodiment of a pixel circuit according to at least one embodiment of the present disclosure;

FIG. 3 is a drive timing diagram of at least one embodiment of the pixel circuit shown in FIG. 2;

FIG. 4 is a structural diagram of a data providing circuit according to embodiments of the present disclosure;

FIG. 5 is a circuit diagram of a data providing circuit according to at least one embodiment of the present disclosure;

FIG. 6 is a circuit diagram of a data providing circuit according to at least one embodiment of the present disclosure;

FIG. 7 is a circuit diagram of a data providing circuit according to at least one embodiment of the present disclosure;

FIG. 8 is a circuit diagram of a verification simulation module;

FIG. 9 is an operational timing diagram of the verification simulation module shown in FIG. 8;

FIG. 10 is a circuit diagram of a verification simulation module;

FIG. 11 is an operational timing diagram of the verification simulation module shown in FIG. 10;

FIG. 12 is a layout diagram of a data providing circuit according to at least one embodiment of the present disclosure;

FIG. 13 is a layout diagram of a semiconductor layer in FIG. 12;

FIG. 14 is a layout diagram of a gate metal layer in FIG. 12;

FIG. 15 is a layout diagram of a source-drain metal layer in FIG. 12;

FIG. 16 is a layout diagram of a data providing circuit according to at least one embodiment of the present disclosure;

FIG. 17 is a layout diagram of a semiconductor layer in FIG. 16;

FIG. 18 is a layout diagram of a gate metal layer in FIG. 16;

FIG. 19 is a layout diagram of a source-drain metal layer in FIG. 16;

FIG. 20 is a structural diagram of at least one embodiment of a pixel circuit;

FIG. 21 is an operational timing diagram of at least one embodiment of the data providing circuit shown in FIG. 7;

FIG. 22 is an operational timing diagram of at least one embodiment of the data providing circuit shown in FIG. 7;

FIG. 23 is an operational timing diagram of at least one embodiment of the data providing circuit shown in FIG. 7; and

FIG. 24 is an operational timing diagram of the verification simulation module shown in FIG. 10 after applying a compensation method in at least one embodiment of the present disclosure.

### DETAILED DESCRIPTION

The technical solutions in embodiments of the present disclosure are described clearly and completely in conjunction with drawings in the embodiments of the present disclosure. Apparently, the described embodiments are merely a part of rather than all the embodiments of the present disclosure. All other embodiments obtained by a person ordinary skilled in the art based on the embodiments of the present disclosure without any creative efforts fall within the protection scope of the present disclosure.

The transistors used in all embodiments of the present disclosure may be thin film transistors, field effect transistors, or other devices having the same characteristics. In the embodiments of the present disclosure, in order to distinguish two terminals of a transistor other than a gate electrode, one of the terminals is referred to as a first terminal, and the other is referred to as a second terminal.

In practical operation, when the transistor is a thin film transistor or a field effect transistor, the first electrode may be a drain electrode, and the second electrode may be a source electrode; or the first electrode may be a source electrode, and the second electrode may be a drain electrode.

A data providing circuit according to embodiments of the present disclosure includes a multiplexing circuit and a reset circuit. N is an integer greater than 1.

The multiplexing circuit is electrically connected to a data voltage providing terminal, N multiplexing control terminals, and N data lines, and is configured to write a data voltage provided by the data voltage providing terminal into an n-th data line under control of an n-th multiplexing control signal provided by an n-th multiplexing control terminal; n is a positive integer less than or equal to N.

The reset circuit is electrically connected to a first multiplexing control terminal, an initial voltage line, and data lines other than a first data line in the N data lines, and is configured to control an initial voltage provided by the initial voltage line to be written into the data lines other than the first data line in the N data lines under control of a first multiplexing control signal provided by the first multiplexing control terminal.

In the data providing circuit according to the embodiments of the present disclosure, the reset circuit is controlled through the first multiplexing control terminal of the N multiplexing control terminals, so as to write the initial voltage into the data lines other than the first data line in the N data lines, which solves the problem of the influence of data voltages of a previous row on the data lines on the writing of data voltages of a next row on the data lines through a combination of the multiplexing circuit and the reset circuit.

In at least one embodiment of the present disclosure, the first data line may be any one of the N data lines. The first data line is not necessarily a first column data line in the display panel when counted from left to right, and is not necessarily a first column data line among the N data lines when counted from left to right.

In at least one embodiment of the present disclosure, the first data line is exemplified as the first column data line. However, in actual operation, the first data line may be any one of the N data lines.

In the related technologies, mainstream light-emitting diode (LED) backplanes depend on splicing process to increase size, so it is needed to compress signal lines within the layout so as to realize seamless splicing. The quantity of data lines affects the width of the splice joint, thus time division multiplexing is generally adopted to reduce the quantity of data lines. Time division multiplexing is also commonly used to reduce the quantity of data voltage providing terminals of source electrode drivers in high PPI (pixel circuit) display.

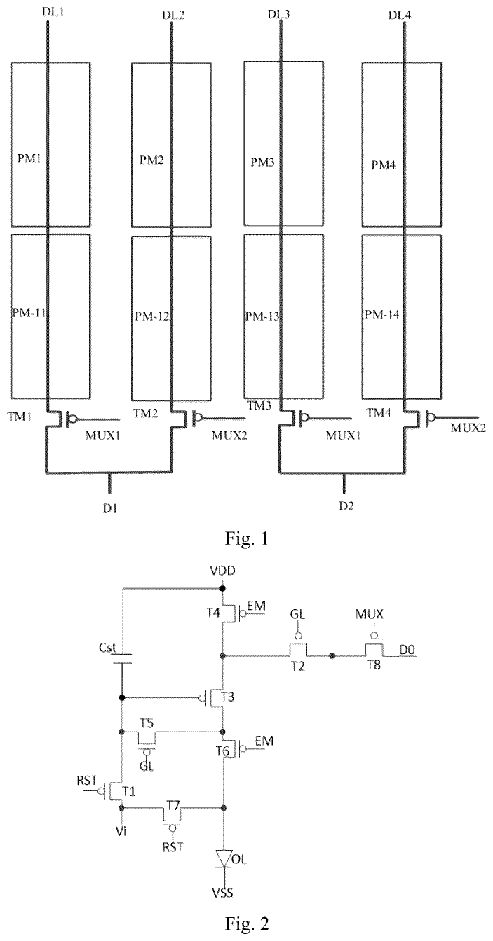

As shown in FIG. 1, in a related data providing circuit, one data voltage providing terminal provides data voltages for two columns of data lines.

In FIG. 1, reference sign D1 denotes a first data voltage providing terminal, and reference sign D2 denotes a second data voltage providing terminal.

Reference sign DL1 denotes a first column data line, reference sign DL2 denotes a second column data line, reference sign DL3 denotes a third column data line, and reference sign DLA denotes a fourth column data line.

Reference sign PM1 denotes a pixel circuit in a first column of an M-th row, reference sign PM2 denotes a pixel circuit in a second column of the M-th row, reference sign PM3 denotes a pixel circuit in a third column of the M-th row, and reference sign PM4 denotes a pixel circuit in a fourth column of the M-th row.

Reference sign PM-11 denotes a pixel circuit in a first column of an (M−1)-th row, reference sign PM-12 denotes a pixel circuit in a second column of the (M−1)-th row, reference sign PM-13 denotes a pixel circuit in a third column of the (M−1)-th row, and reference sign PM-14 denotes a pixel circuit in a fourth column of the (M−1)-th row.

M is an integer greater than 1.

In at least one embodiment of the present disclosure, the first column data line DL1, the second column data line DL2, the third column data line DL3, and the fourth column data line DL4 are any four adjacent data lines included in the display panel, and are not necessarily the first four column data lines included in the display panel.

In addition, the first column data line DL1 is not necessarily a first one of column data lines among the four data lines when counted from left to right, the second column data line DL2 is not necessarily a second one of column data lines among the four data lines when counted from left to right, the third column data line DL3 is not necessarily a third one of column data lines among the four data lines when counted from left to right, and the fourth column data line DL4 is not necessarily a fourth one of column data lines among the four data lines when counted from left to right.

In FIG. 1, reference sign TM1 denotes a first multiplexing transistor, reference sign TM2 denotes a second multiplexing transistor, reference sign TM3 denotes a third multiplexing transistor, and reference sign TM4 denotes a fourth multiplexing transistor.

A gate electrode of the TM1 is electrically connected to a first multiplexing control terminal MUX1, a source electrode of the TM1 is electrically connected to the first data voltage providing terminal D1, and a drain electrode of the TM1 is electrically connected to the first column data line DL1.

A gate electrode of the TM2 is electrically connected to a second multiplexing control terminal MUX2, a source electrode of the TM2 is electrically connected to the first data voltage providing terminal D1, and a drain electrode of the TM2 is electrically connected to the second column data line DL2.

A gate electrode of the TM3 is electrically connected to the first multiplexing control terminal MUX1, a source electrode of the TM3 is electrically connected to the second data voltage providing terminal D2, and a drain electrode of the TM3 is electrically connected to the third column data line DL3.

A gate electrode of the TM4 is electrically connected to the second multiplexing control terminal MUX2, a source electrode of the TM4 is electrically connected to the second data voltage providing terminal D2, and a drain electrode of the TM4 is electrically connected to the fourth column data line DL4.

In FIG. 1, TM1, TM2, TM3, and TM4 are all p-type transistors, but are not limited thereto.

FIG. 2 is a circuit diagram of at least one embodiment of a pixel circuit in at least one embodiment of the present disclosure.

As shown in FIG. 2, the pixel circuit of at least one embodiment includes a first transistor T1, a second transistor T2, a drive transistor T3, a fourth transistor T4, a fifth transistor T5, a sixth transistor T6, a seventh transistor T7, an eighth transistor T8, a storage capacitor Cst, and an organic LED OL.

A gate electrode of T1 is electrically connected to a reset line RST, a source electrode of T1 is connected to a reset signal Vi, and a drain electrode of T1 is electrically connected to a gate electrode of T3.

A gate electrode of T2 is electrically connected to a scanning line GL, a source electrode of T2 is electrically connected to a source electrode of T3, and a drain electrode of T2 is electrically connected to a drain electrode of T8.

A drain electrode of T3 is electrically connected to a source electrode of T6.

A gate electrode of T4 is electrically connected to a light-emitting control line EM, a source electrode of T4 is electrically connected to a high-voltage terminal VDD, and a drain electrode of T4 is electrically connected to a source electrode of T3.

A gate electrode of T5 is electrically connected to the scanning line GL, a source electrode of T5 is electrically connected to a gate electrode of T3, and a drain electrode of T5 is electrically connected to the drain electrode of T3.

A gate electrode of T6 is electrically connected to the light-emitting control line EM, a source electrode of T6 is electrically connected to the drain electrode of T3, a drain electrode of T6 is electrically connected to an anode of the OL, and a cathode of the OL is electrically connected to a low-voltage terminal VSS.

A gate electrode of T7 is electrically connected to the reset line RST, a source electrode of T7 is connected to the reset voltage Vi, and a drain electrode of T7 is electrically connected to the anode of the OL.

A gate electrode of T8 is electrically connected to the multiplexing control terminal MUX, and a source electrode of T8 is electrically connected to the data voltage providing terminal DO.

In at least one embodiment of the pixel circuit shown in FIG. 2, all transistors are p-type transistors, but are not limited thereto.

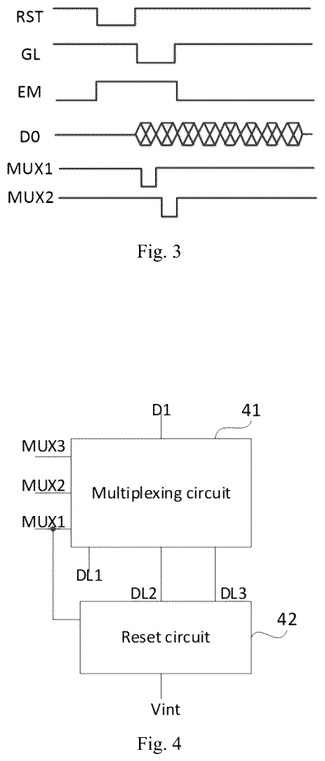

In FIG. 3, reference sign MUX1 denotes a first multiplexing control terminal, and reference sign MUX2 denotes a second multiplexing control terminal.

According to the drive timing sequence in FIG. 3, when the pixel circuit of at least one embodiment shown in FIG. 2 is in operation, and in a case that the gate electrode of T8 in FIG. 2 is electrically connected to the second multiplexing control terminal MUX2:

After the scanning line GL is turned on, and after the data writing of the (M−1)-th row is completed, the data writing of the M-th row is started; after the pixel circuit is initialized, the MUX2 in FIG. 2 is turned on; in this case, before the MUX2 is turned on, the data voltage of the (M−1)-th row may be written into the gate electrode of T3 in FIG. 2, thereby causing erroneous writing of the data voltage of the M-th row. Meanwhile, it is also noted that the above-mentioned effect occurs when the data voltage of the (M−1)-th row is higher than the data voltage of the M-th row; if the data voltage of the (M−1)-th row is a high data voltage VDH and the data voltage of the M-th row is a low data voltage VDL, a potential of the gate electrode of T3 will first be written as VDH+Vth, so a gate-source voltage written into T3 of the pixel circuit of the M-th row will become VDH+Vth−(VDL+Vth), that is, the gate-source voltage of the pixel circuit of the M-th row will become VDH-VGL, and the gate-source voltage is greater than 0; at this time, T3 in the pixel circuit of the M-th row is turned off, and the data voltage VDL of the M-th row that needs to be written into the pixel circuit of the M-th row can not be written normally.

In the related technologies, the scanning line and the multiplexing control terminal are turned on in a time division manner. However, in at least one embodiment of the present disclosure, when the scanning line is turned on, at least two rows of data voltages are written successively, which saves time. Therefore, at least one embodiment of the present disclosure is applicable to high-frequency display products.

As shown in FIG. 4, the data providing circuit according to the embodiments of the present disclosure includes a multiplexing circuit 41 and a reset circuit 42. N is an integer greater than 1.

The multiplexing circuit 41 is electrically connected to a first data voltage providing terminal D1, a first multiplexing control terminal MUX1, a second multiplexing control terminal MUX2, a third multiplexing control terminal MUX3, a first column data line DL1, a second column data line DL2, and a third column data line DL3, and is configured to write a data voltage provided by the first data voltage providing terminal D1 into the first column data line DL1 under the control of a first multiplexing control signal provided by the first multiplexing control terminal MUX1, write the data voltage provided by the first data voltage providing terminal D1 into the second column data line DL2 under the control of a second multiplexing control signal provided by the second multiplexing control terminal MUX2, and write the data voltage provided by the first data voltage providing terminal D1 into the third column data line DL3 under the control of a third multiplexing control signal provided by the third multiplexing control terminal MUX3.

The reset circuit 42 is electrically connected to the first multiplexing control terminal MUX1, an initial voltage line, the second column data line DL2, and the third column data line DL3 and is configured to control the initial voltage Vint provided by the initial voltage line to be written into the second column data line DL2 and the third column data line DL3 under the control of the first multiplexing control signal provided by the first multiplexing control terminal MUX1.

The data providing circuit of the embodiments of the present disclosure can solve the problem of mutual interference of data voltages of adjacent rows of pixel circuits in a case where the scanning line and the multiplexing control terminal are turned on at the same time. When the multiplexing circuit 41 writes the data voltage provided by the first data voltage providing terminal D1 into the first column data line DL1 under the control of the first multiplexing control signal, the initial voltage Vint is controlled to be written into the second column data line DL2 and the third column data line DL3 by the reset circuit 42 under the control of the first multiplexing control signal, to reset the second column data line DL2 and the third column data line DL3, so as to solve the problem of the influence of a previous row of data voltages on the data lines on the writing of a next row of data voltages on the data lines. Furthermore, as compared with a case where the scanning lines are turned on after all the multiplexing control terminals are turned off, the flexibility of the driving timing is increased, and the influence of the interlayer capacitance of adjacently arranged data lines can also be reduced.

Optionally, the reset circuit includes M reset sub-circuits; M is equal to N−1; m is a positive integer less than or equal to M.

A control terminal of an m-th reset sub-circuit is electrically connected to the first multiplexing control terminal, a first terminal of the m-th reset sub-circuit is electrically connected to the initial voltage line, and a second terminal of the m-th reset sub-circuit is electrically connected to an (m+1)-th data line.

The m-th reset sub-circuit is configured to write the initial voltage provided by the initial voltage line into the (m+1)-th data line under the control of the first multiplexing control signal provided by the first multiplexing control terminal.

Optionally, the m-th reset sub-circuit may include an m-th reset transistor.

A gate electrode of the m-th reset transistor is electrically connected to the first multiplexing control terminal, a first electrode of the m-th reset transistor is electrically connected to the initial voltage line, and a second electrode of the m-th reset transistor is electrically connected to the (m+1)-th data line.

Optionally, the M reset transistors are all p-type transistors, or the M reset transistors are all n-type transistors, which are not limited thereto. In specific implementations, the reset transistor may be a p-type transistor or an n-type transistor, and the type of the reset transistor varies according to the timing of a multiplexing control signal connected to its gate electrode.

In at least one embodiment of the present disclosure, the m-th reset sub-circuit may include at least two reset transistors connected in series with each other, and gate electrodes of the at least two reset transistors may be electrically connected to the first multiplexing control terminal.

For example, in a case that the m-th reset sub-circuit includes two reset transistors connected in series with each other:
a gate electrode of a first one of the reset transistors included in the m-th reset sub-circuit may be electrically connected to the first multiplexing control terminal, a first electrode of the first one of the reset transistors included in the m-th reset sub-circuit may be electrically connected to the initial voltage line, and a second electrode of the first one of the reset transistors included in the m-th reset sub-circuit may be electrically connected to a first electrode of a second one of the reset transistors included in the m-th reset sub-circuit;
a gate electrode of the second one of the reset transistors included in the m-th reset sub-circuit may be electrically connected to the first multiplexing control terminal, and a second electrode of the second one of the reset transistors included in the m-th reset sub-circuit may be electrically connected to an (m+1)-th data line. In at least one embodiment of the present disclosure, the multiplexing circuit includes N multiplexing sub-circuits;
a control terminal of an n-th multiplexing sub-circuit is electrically connected to the n-th multiplexing control terminal, a first terminal of the n-th multiplexing sub-circuit is electrically connected to the data voltage providing terminal, and a second terminal of the n-th multiplexing sub-circuit is electrically connected to the n-th data line;
the n-th multiplexing sub-circuit is configured to write the data voltage provided by the data voltage providing terminal into the n-th data line under the control of the n-th multiplexing control signal provided by the n-th multiplexing control terminal.

Optionally, the n-th multiplexing sub-circuit may include an n-th multiplexing transistor.

A gate electrode of the n-th multiplexing transistor is electrically connected to the n-th multiplexing control terminal, a first electrode of the n-th multiplexing transistor is electrically connected to the data voltage providing terminal, and a second electrode of the n-th multiplexing transistor is electrically connected to the n-th data line.

In at least one embodiment of the present disclosure, the n-th multiplexing sub-circuit may include at least two multiplexing transistors connected in series with each other, and gate electrodes of the at least two multiplexing transistors are electrically connected to the n-th multiplexing control terminal.

For example, in a case that the n-th multiplexing sub-circuit includes two multiplexing transistors connected in series with each other:
a gate electrode of a first one of the multiplexing transistors included in the n-th multiplexing sub-circuit may be electrically connected to an n-th multiplexing control terminal, a first electrode of the first one of the multiplexing transistors included in the n-th multiplexing sub-circuit may be electrically connected to the data voltage providing terminal, and a second electrode of the first one of the multiplexing transistors included in the n-th multiplexing sub-circuit may be electrically connected to a second one of the multiplexing transistors included in the n-th multiplexing sub-circuit;
a gate electrode of the second one of the multiplexing transistors included in the n-th multiplexing sub-circuit may be electrically connected to the n-th multiplexing control terminal, and a second electrode of the second one of the multiplexing transistors included in the n-th multiplexing sub-circuit may be electrically connected to the n-th data line.

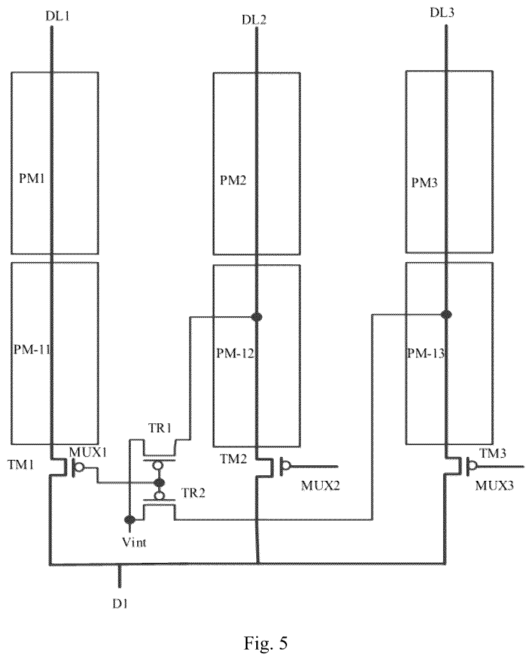

In FIG. 5, reference sign PM1 denotes a pixel circuit in a first column of the M-th row, reference sign PM2 denotes a pixel circuit in a second column of the M-th row, and reference sign PM3 denotes a pixel circuit in a third column of the M-th row.

Reference sign PM-11 denotes a pixel circuit in a first column of an (M−1)-th row, reference sign PM-12 denotes a pixel circuit in a second column of the (M−1)-th row, and reference sign PM-13 denotes a pixel circuit in a third column of the (M−1)-th row.

PM1 and PM-11 are both electrically connected to the first column data line DL1, PM2 and PM-12 are both electrically connected to the second column data line DL2, and PM3 and PM-13 are both electrically connected to the third column data line DL3.

M is an integer greater than 1.

As shown in FIG. 5, on the basis of the embodiment of the data providing circuit shown in FIG. 4,
the multiplexing circuit includes a first multiplexing transistor TM1, a second multiplexing transistor TM2, and a third multiplexing transistor TM3;
the reset circuit includes a first reset transistor TR1 and a second reset transistor TR2.

A gate electrode of the TM1 is electrically connected to a first multiplexing control terminal MUX1, a source electrode of the TM1 is electrically connected to the first data voltage providing terminal D1, and a drain electrode of the TM1 is electrically connected to the first column data line DL1.

A gate electrode of the TM2 is electrically connected to a second multiplexing control terminal MUX2, a source electrode of the TM2 is electrically connected to the first data voltage providing terminal D1, and a drain electrode of the TM2 is electrically connected to the second column data line DL2.

A gate electrode of the TM3 is electrically connected to the third multiplexing control terminal MUX3, a source electrode of the TM3 is electrically connected to the first data voltage providing terminal D1, and a drain electrode of the TM3 is electrically connected to the third column data line DL3.

A gate electrode of the TR1 is electrically connected to the first multiplexing control terminal MUX1, a source electrode of the TR1 is connected to the initial voltage Vint, and a drain electrode of the TR1 is electrically connected to the second column data line DL2.

A gate electrode of the TR2 is electrically connected to the first multiplexing control terminal MUX1, a source electrode of the TR2 is connected to the initial voltage Vint, and a drain electrode of the TR2 is electrically connected to the third column data line DL3.

In at least one embodiment shown in FIG. 5, TM1, TM2, TM3, TR1, and TR2 are all p-type transistors, but are not limited thereto.

In at least one embodiment shown in FIG. 5, a case where N is equal to 3 is taken as an example.

A display substrate according to embodiments of the present disclosure includes a base and the above-mentioned data providing circuit provided on the base.

In at least one embodiment of the present disclosure, the reset circuit in the data providing circuit may include M reset sub-circuits. M is equal to N−1; m is a positive integer less than or equal to M.

A control terminal of an m-th reset sub-circuit is electrically connected to the first multiplexing control terminal, a first terminal of the m-th reset sub-circuit is electrically connected to the initial voltage line, and a second terminal of the m-th reset sub-circuit is electrically connected to an (m+1)-th data line. The m-th reset sub-circuit is configured to write an initial voltage provided by the initial voltage line into the (m+1)-th data line under the control of a first multiplexing control signal provided by the first multiplexing control terminal.

A first terminal of a reset sub-circuit in the M reset sub-circuits may be also used as a first terminal of another multiplexing sub-circuit in the M reset sub-circuits.

In at least one embodiment of the present disclosure, the multiplexing circuit in the data providing circuit includes N multiplexing sub-circuits.

A control terminal of an n-th multiplexing sub-circuit is electrically connected to an n-th multiplexing control terminal, a first terminal of the n-th multiplexing sub-circuit is electrically connected to the data voltage providing terminal, and a second terminal of the n-th multiplexing sub-circuit is electrically connected to an n-th data line. The n-th multiplexing sub-circuit is configured to write a data voltage provided by the data voltage providing terminal into the n-th data line under the control of an n-th multiplexing control signal provided by the n-th multiplexing control terminal.

The second terminal of the n-th multiplexing sub-circuit is also used as a second terminal of an (n−1)-th reset sub-circuit.

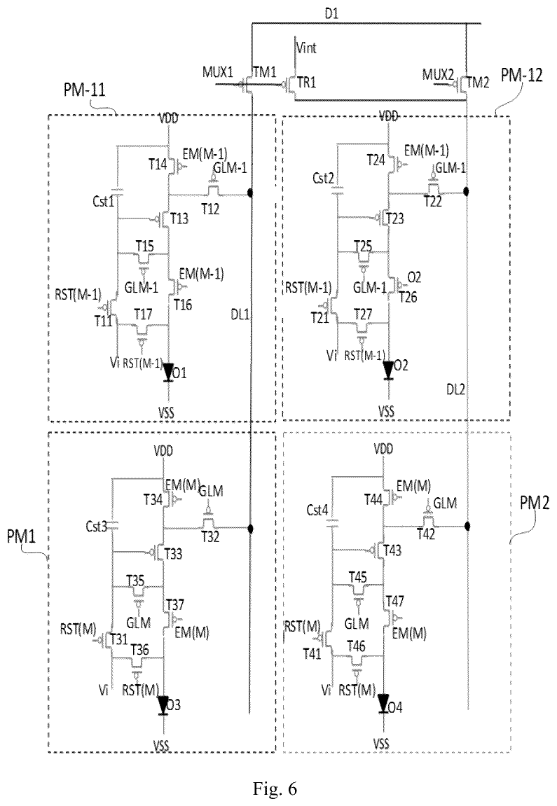

As shown in FIG. 6, reference sign PM1 denotes a pixel circuit in a first column of an M-th row, and reference sign PM2 denotes a pixel circuit in a second column of the M-th row.

Reference sign PM-11 denotes a pixel circuit in a first column of an (M−1)-th row, and reference sign PM-12 denotes a pixel circuit in a second column of the (M−1)-th row.

The PM-11 includes the first one of first transistors T11, the first one of second transistors T12, a first drive transistor T13, the first one of fourth transistors T14, the first one of fifth transistors T15, the first one of sixth transistors T16, the first one of seventh transistors T17, a first storage capacitor Cst1, and a first organic LED O1.

The PM-12 includes the second one of the first transistors T21, the second one of the second transistors T22, a second drive transistor T23, the second one of the fourth transistors T24, the second one of the fifth transistors T25, the second one of the sixth transistors T26, the second one of the seventh transistors T27, a second storage capacitor Cst2, and a second organic LED O2.

The PM1 includes the third one of the first transistors T31, the third one of the second transistors T32, a third drive transistor T33, the third one of the fourth transistors T34, the third one of the fifth transistors T35, the third one of the sixth transistors T36, the third one of the seventh transistors T37, a third storage capacitor Cst3, and a third organic LED O3.

The PM2 includes the fourth one of the first transistors T41, the fourth one of the second transistors T42, a fourth drive transistor T43, the fourth one of the fourth transistors T44, the fourth one of the fifth transistors T45, the fourth one of the sixth transistors T46, the fourth one of the seventh transistors T47, a fourth storage capacitor Cst4, and a fourth organic LED O4.

In FIG. 6, reference sign DL1 denotes a first column data line, reference sign DL2 denotes a second column data line, and reference sign D1 denotes a first data voltage providing terminal.

Reference sign VDD denotes a high-voltage terminal, reference sign EM (M−1) denotes a light-emitting control line of an (M−1)-th row, and reference sign EM (M) denotes a light-emitting control line of an M-th row.

Reference sign GLM-1 denotes a scanning line of the (M−1)-th row, and reference sign GLM denotes a scanning line of the M-th row.

Reference sign RST (M−1) denotes a reset line of the (M−1)-th row, and reference sign RST (M) denotes a reset line of the M-th row.

Reference sign Vi denotes a reset voltage, reference sign VDD denotes a high-voltage terminal, reference sign VSS denotes a low-voltage terminal, and reference sign Vint denotes an initial voltage.

In at least one embodiment shown in FIG. 6, N is equal to 2.

The data providing circuit according to at least one embodiment includes a first multiplexing transistor TM1, a second multiplexing transistor TM2, and a first reset transistor TR1.

A gate electrode of the TM1 is electrically connected to a first multiplexing control terminal MUX1, a source electrode of the TM1 is electrically connected to the first data voltage providing terminal D1, and a drain electrode of the TM1 is electrically connected to the first column data line DL1.

A gate electrode of the TM2 is electrically connected to a second multiplexing control terminal MUX2, a source electrode of the TM2 is electrically connected to the first data voltage providing terminal D1, and a drain electrode of the TM2 is electrically connected to the second column data line DL2.

A gate electrode of the TR1 is electrically connected to the first multiplexing control terminal MUX1, a source electrode of the TR1 is connected to the initial voltage Vint, and a drain electrode of the TR1 is electrically connected to the second column data line DL2.

When the MUX1 provides a low-voltage signal, TM1 and TR1 are turned on, a data voltage provided by the first data voltage providing terminal D1 is written into the first column data line DL1, and the initial voltage Vint is written into the second column data line DL2.

When the MUX2 provides a low-voltage signal, the TM2 is turned on, and a data voltage provided by the first data voltage providing terminal D1 is written into the second column data line DL2.

In at least one embodiment shown in FIG. 6, Vi and Vint may be the same or may be different.

In at least one embodiment of the present disclosure, when T3 in the pixel circuit is a p-type transistor, Vint may be a relatively low value so that the difference between Vint and the data voltage is less than a threshold voltage of T3.

When T3 in the pixel circuit is an n-type transistor, Vint may be a relatively high value so that the difference between Vint and the data voltage is greater than the threshold voltage of T3.

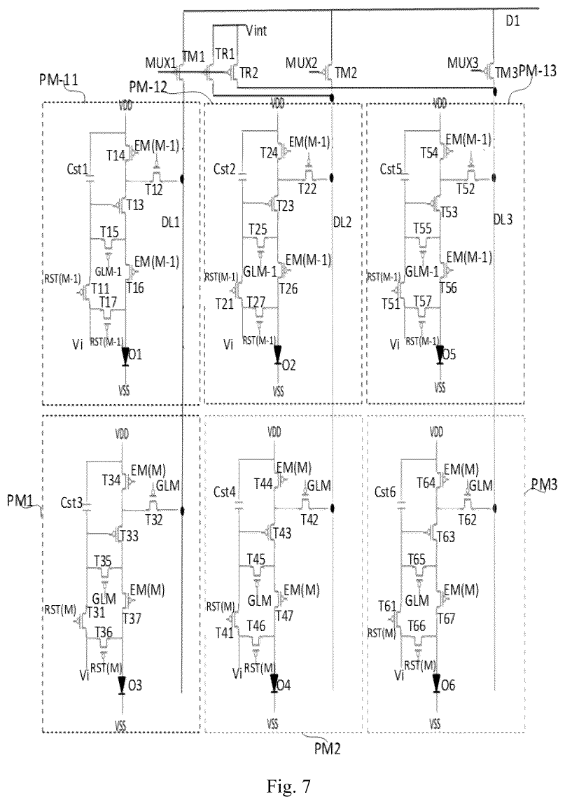

As shown in FIG. 7, reference sign PM1 denotes a pixel circuit in a first column of an M-th row, reference sign PM2 denotes a pixel circuit in a second column of the M-th row, and reference sign PM3 denotes a pixel circuit in a third column of the M-th row.

Reference sign PM-11 denotes a pixel circuit in a first column of an (M−1)-th row, reference sign PM-12 denotes a pixel circuit in a second column of the (M−1)-th row, and reference sign PM-13 denotes a pixel circuit in a third column of the (M−1)-th row.

The PM-11 includes the first one of first transistors T11, the first one of second transistors T12, a first drive transistor T13, the first one of fourth transistors T14, the first one of fifth transistors T15, the first one of sixth transistors T16, the first one of seventh transistors T17, a first storage capacitor Cst1, and a first organic LED O1.

The PM-12 includes the second one of the first transistors T21, the second one of the second transistors T22, a second drive transistor T23, the second one of the fourth transistors T24, the second one of the fifth transistors T25, the second one of the sixth transistors T26, the second one of the seventh transistors T27, a second storage capacitor Cst2, and a second organic LED O2.

The PM-13 includes the fifth one of the first transistors T51, the fifth one of the second transistors T52, a fifth drive transistor T53, the fifth one of the fourth transistors T54, the fifth one of the fifth transistors T55, the fifth one of the sixth transistors T56, the fifth one of the seventh transistors T57, a fifth storage capacitor Cst5, and a fifth organic LED O5.

The PM1 includes the third one of the first transistors T31, the third one of the second transistors T32, a third drive transistor T33, the third one of the fourth transistors T34, the third one of the fifth transistors T35, the third one of the sixth transistors T36, the third one of the seventh transistors T37, a third storage capacitor Cst3, and a third organic LED O3.

The PM2 includes the fourth one of the first transistors T41, the fourth one of the second transistors T42, a fourth drive transistor T43, the fourth one of the fourth transistors T44, the fourth one of the fifth transistors T45, the fourth one of the sixth transistors T46, the fourth one of the seventh transistors T47, a fourth storage capacitor Cst4, and a fourth organic LED O4.

The PM3 includes the sixth one of the first transistors T61, the sixth one of the second transistors T62, a sixth drive transistor T63, the sixth one of the fourth transistors T64, the sixth one of the fifth transistors T65, the sixth one of the sixth transistors T66, the sixth one of the seventh transistors T67, a sixth storage capacitor Cst6, and a sixth organic LED O6.

In FIG. 7, reference sign DL1 denotes a first column data line, reference sign DL2 denotes a second column data line, reference sign DL3 denotes a third column data line, and reference sign D1 denotes a first data voltage providing terminal.

Reference sign VDD denotes a high-voltage terminal, reference sign EM (M−1) denotes a light-emitting control line of an (M−1)-th row, and reference sign EM (M) denotes a light-emitting control line of an M-th row.

Reference sign GLM-1 denotes a scanning line of the (M−1)-th row, and reference sign GLM denotes a scanning line of the M-th row.

Reference sign RST (M−1) denotes a reset line of the (M−1)-th row, and reference sign RST (M) denotes a reset line of the M-th row.

Reference sign Vi denotes a reset voltage, reference sign VSS denotes a low-voltage terminal, and reference sign Vint denotes an initial voltage.

In at least one embodiment shown in FIG. 7, N is equal to 3.

The data providing circuit according to least one embodiment includes a first multiplexing transistor TM1, a second multiplexing transistor TM2, a third multiplexing transistor TM3, a first reset transistor TR1, and a second reset transistor TR2.

A gate electrode of the TM1 is electrically connected to a first multiplexing control terminal MUX1, a source electrode of the TM1 is electrically connected to the first data voltage providing terminal D1, and a drain electrode of the TM1 is electrically connected to the first column data line DL1.

A gate electrode of the TM2 is electrically connected to a second multiplexing control terminal MUX2, a source electrode of the TM2 is electrically connected to the first data voltage providing terminal D1, and a drain electrode of the TM2 is electrically connected to the second column data line DL2.

A gate electrode of the TM3 is electrically connected to a third multiplexing control terminal MUX3, a source electrode of the TM3 is electrically connected to the first data voltage providing terminal D1, and a drain electrode of the TM3 is electrically connected to the third column data line DL3.

A gate electrode of the TR1 is electrically connected to the first multiplexing control terminal MUX1, a source electrode of the TR1 is connected to the initial voltage Vint, and a drain electrode of the TR1 is electrically connected to the second column data line DL2.

A gate electrode of the TR2 is electrically connected to the first multiplexing control terminal MUX1, a source electrode of the TR2 is connected to the initial voltage Vint, and a drain electrode of the TR2 is electrically connected to the third column data line DL3.

When the MUX1 provides a low-voltage signal, TM1, TR1, and TR2 are turned on, a data voltage provided by the first data voltage providing terminal D1 is written into the first column data line DL1, and the initial voltage Vint is written into the second column data line DL2 and the third column data line DL3.

In at least one embodiment shown in FIG. 7, Vi and Vint may be the same or may be different.

In at least one embodiment of the present disclosure, when T3 in the pixel circuit is a p-type transistor, Vint may be a relatively low value so that the difference between Vint and the data voltage is less than a threshold voltage of T3.

When T3 in the pixel circuit is an n-type transistor, Vint may be a relatively high value so that the difference between Vint and the data voltage is greater than the threshold voltage of T3.

The process of verifying the technical solutions of the embodiments of the present disclosure is described below by taking a case where N is equal to 3 as an example.

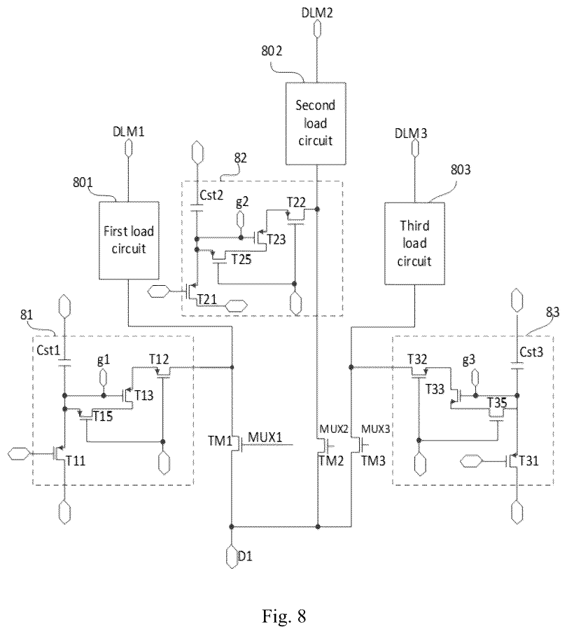

As shown in FIG. 8, a verification simulation module is designed.

The verification simulation module includes a first drive circuit 81, a second drive circuit 82, a third drive circuit 83, a first load circuit 801, a second load circuit 802, a third load circuit 803, a first analogue data line DLM1, a second analogue data line DLM2, a third analogue data line DLM3, a data providing circuit 80, and a verification module.

The first drive circuit 81 includes a first drive transistor T13, the first one of second transistors T12, the first one of first transistors T11, the first one of fifth transistors T15, and a first storage capacitor Cst1.

The second drive circuit 82 includes a second drive transistor T23, the second one of second transistors T22, the second one of first transistors T21, the second one of fifth transistors T25, and a second storage capacitor Cst2.

The third drive circuit 83 includes a third drive transistor T33, the third one of second transistors T32, the third one of first transistors T31, the third one of fifth transistors T35, and a third storage capacitor Cst3.

The data providing circuit 80 includes a first multiplexing transistor TM1, a second multiplexing transistor TM2, and a third multiplexing transistor TM3.

A gate electrode of the TM1 is electrically connected to the first multiplexing control terminal MUX1, a source electrode of the TM1 is electrically connected to the first data voltage providing terminal D1, and a drain electrode of the TM1 is electrically connected to the T12 and the first load circuit 801.

A gate electrode of the TM2 is electrically connected to the second multiplexing control terminal MUX2, a source electrode of the TM2 is electrically connected to the first data voltage providing terminal D1, and a drain electrode of the TM2 is electrically connected to the T22 and the second load circuit 802.

A gate electrode of the TM3 is electrically connected to the third multiplexing control terminal MUX3, a source electrode of the TM3 is electrically connected to the first data voltage providing terminal D1, and a drain electrode of the TM3 is electrically connected to the T32 and the third load circuit 803.

The first load circuit 801 simulates the coupling capacitor and the resistor on the first column data line, the second load circuit 802 simulates the coupling capacitor and the resistor on the second column data line, and the third load circuit 803 simulates the coupling capacitor and the resistor on the third column data line.

The DLM1 is electrically connected to T12 through the first load circuit 801, the DLM2 is electrically connected to T22 through the second load circuit 802, and the DLM3 is electrically connected to T32 through the third load circuit 803.

In FIG. 8, reference sign RST denotes a reset line, reference sign GL denotes a scanning line, reference sign VDD denotes a high-voltage terminal, and Vi denotes a reset voltage.

In FIG. 8, a gate electrode of T13 is a first gate monitoring point g1, a gate electrode of T23 is a second gate monitoring point g2, and a gate electrode of T33 is a third gate monitoring point g3. A first data line monitoring point is set on the DLM1, a second data line monitoring point is set on the DLM2, and a third data line monitoring point is set on the DLM3.

When performing simulation verification based on the verification simulation module in FIG. 8, the verification module may control to provide a data voltage, a scanning signal, and a reset signal, and detect the potentials of the monitoring points. First, the first data voltage providing terminal D1 may input an 8V voltage in three pulses (for low greyscale display), g1, g2, and g3 may all charge to about 7.1V, and the data voltage on DL1, the data voltage on DL2, and the data voltage on DL3 may finally maintain at about 7V. Subsequently, the RST is turned on, and after the potential of the gate electrode of the each drive transistor is reset through the reset voltage Vi, the first data voltage providing terminal D1 inputs a 3V voltage (for high greyscale display). Due to the retained 7V voltage on the capacitor of the data line, the MUX1 is turned on at the same time with the signal on the scanning line, i.e., a normal 2.5V voltage is written into the potential of g1, but the potential of g2 and the potential of g3 are about 6.3V, i.e., resulting in abnormal writing.

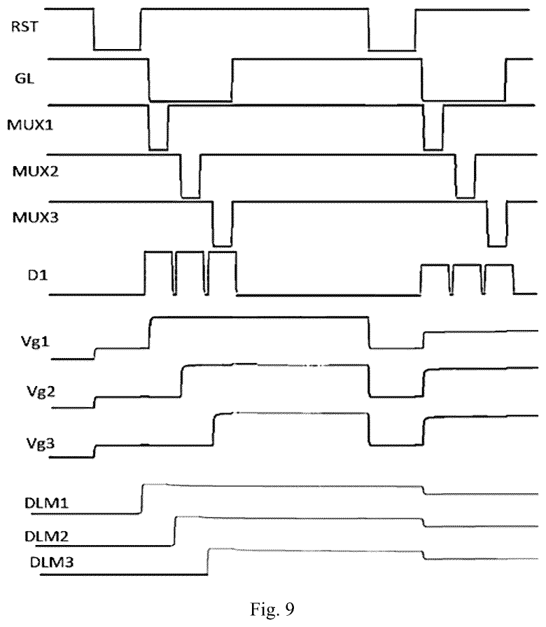

FIG. 9 is an operational timing diagram of the verification simulation module shown in FIG. 8.

In FIG. 9, Vg1 is the potential of g1, Vg2 is the potential of g2, and Vg3 is the potential of g3.

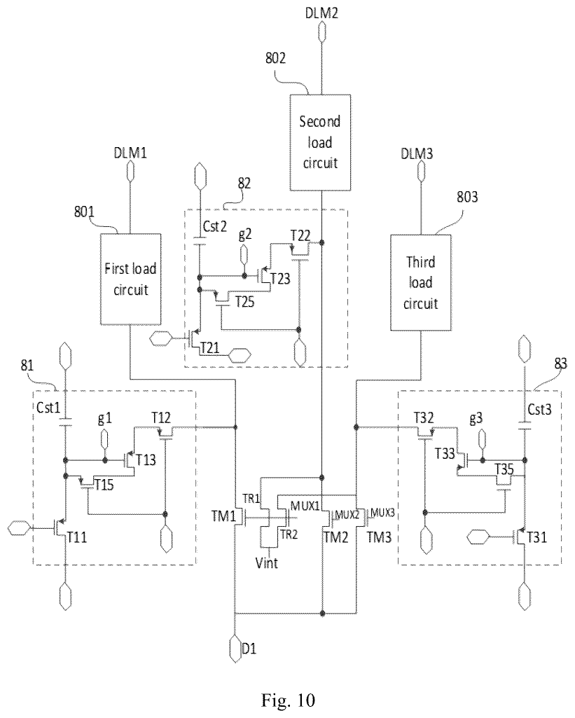

As shown in FIG. 10, a verification simulation module is designed.

The verification simulation module includes a first drive circuit 81, a second drive circuit 82, a third drive circuit 83, a first load circuit 801, a second load circuit 802, a third load circuit 803, a first analogue data line DLM1, a second analogue data line DLM2, a third analogue data line DLM3, a data providing circuit 80, and a verification module.

The first drive circuit 81 includes a first drive transistor T13, the first one of second transistors T12, the first one of first transistors T11, the first one of fifth transistors T15, and a first storage capacitor Cst1.

The second drive circuit 82 includes a second drive transistor T23, the second one of the second transistors T22, the second one of the first transistors T21, the second one of the fifth transistors T25, and a second storage capacitor Cst2.

The third drive circuit 83 includes a third drive transistor T33, the third one of the second transistors T32, the third one of the first transistors T31, the third one of the fifth transistors T35, and a third storage capacitor Cst3.

The data providing circuit 80 includes a first multiplexing transistor TM1, a second multiplexing transistor TM2, a third multiplexing transistor TM3, a first reset transistor TR1, and a second reset transistor TR2.

A gate electrode of the TM1 is electrically connected to the first multiplexing control terminal MUX1, a source electrode of the TM1 is electrically connected to the first data voltage providing terminal D1, and a drain electrode of the TM1 is electrically connected to the T12 and the first load circuit 801.

A gate electrode of the TM2 is electrically connected to the second multiplexing control terminal MUX2, a source electrode of the TM2 is electrically connected to the first data voltage providing terminal D1, and a drain electrode of the TM2 is electrically connected to the T22 and the second load circuit 802.

A gate electrode of the TM3 is electrically connected to the third multiplexing control terminal MUX3, a source electrode of the TM3 is electrically connected to the first data voltage providing terminal D1, and a drain electrode of the TM3 is electrically connected to the T32 and the third load circuit 803.

A gate electrode of the TR1 is electrically connected to the first multiplexing control terminal MUX1, a source electrode of the TR1 is connected to the initial voltage Vint, and a drain electrode of the TR1 is electrically connected to the second load circuit 802.

A gate electrode of the TR2 is electrically connected to the first multiplexing control terminal MUX1, a source electrode of the TR1 is connected to the initial voltage Vint, and a drain electrode of the TR1 is electrically connected to the third load circuit 803.

The first load circuit 801 simulates the coupling capacitor and the resistor on the first column data line, the second load circuit 802 simulates the coupling capacitor and the resistor on the second column data line, and the third load circuit 803 simulates the coupling capacitor and the resistor on the third column data line.

The DLM1 is electrically connected to T12 through the first load circuit 801, the DLM2 is electrically connected to T22 through the second load circuit 802, and the DLM3 is electrically connected to T32 through the third load circuit 803.

In FIG. 10, reference sign RST denotes a reset line, reference sign GL denotes a scanning line, reference sign VDD denotes a high-voltage terminal, and Vi denotes a reset voltage.

In FIG. 10, a gate electrode of T13 is a first gate monitoring point g1, a gate electrode of T23 is a second gate monitoring point g2, and a gate electrode of T33 is a third gate monitoring point g3. A first data line monitoring point is set on the DLM1, a second data line monitoring point is set on the DLM2, and a third data line monitoring point is set on the DLM3.

When performing simulation verification based on the verification simulation module in FIG. 10, the verification module may control to provide a data voltage, a scanning signal, and a reset signal, and detect the potentials of the monitoring points.

First, the first data voltage providing terminal D1 may input an 8V voltage in three pulses (for low greyscale display), g1, g2, and g3 may all charge to about 7.1V, and the data voltage on DL1, the data voltage on DL2, and the data voltage on DL3 may finally maintain at about 7V. Subsequently, the RST is turned on, and after the potential of the gate electrode of the each drive transistor is reset through the reset voltage Vi, the first data voltage providing terminal D1 inputs a 3V voltage (for high greyscale display). When the MUX1 provides an effective first multiplexing control signal, TM1, TR1, and TR2 are simultaneously turned on, and the Vint simultaneously resets a 7.1V voltage stored in the coupling capacitor on the DL2 and a 7.1V voltage stored in the coupling capacitor on the DL3, so when turn-on signals of the MUX2 and the MUX3 arrive, the 3V data voltage is written, and through the simulation structure, a 2.53V voltage is written into g1, a 2.44V voltage is written into g2, and a 2.26V voltage is written into g3.

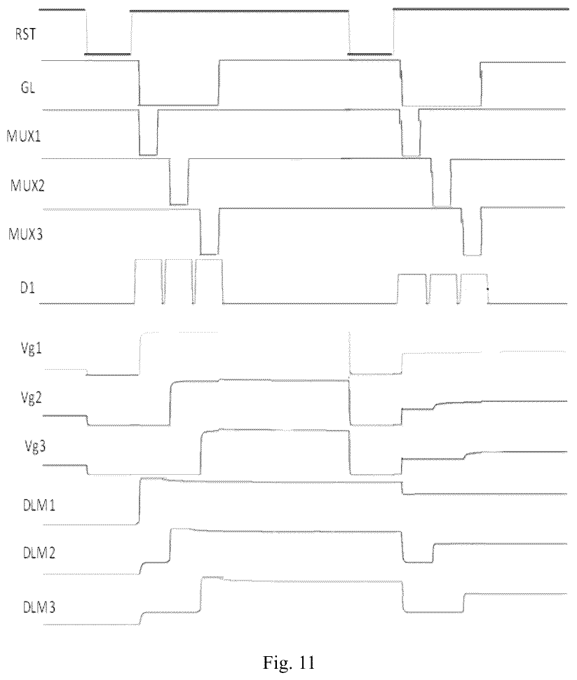

FIG. 11 is an operational timing diagram of the verification simulation module shown in FIG. 10.

A case where N is equal to 3 is taken as an example. In the design of a data providing circuit, it is common to adopt a channel width-length ratio of 100/5 for each multiplexing transistor, a line width of a data line is at least 5 μm, and a spacing between the data lines is at least 3 μm. A first multiplexing transistor TM1, a first reset transistor TR1, and a second reset transistor TR2 share a same gate electrode. When the first multiplexing control terminal MUX1 is turned on and a signal arrives, the DL2 and the DL3 are reset through the TR1 and the TR2. When the TR2 resets the DL3, a via hole structure and a scanning line are required to form a jumper line, which passes through the DL2. The above connection method is conventional, it not only occupies a large layout area, but also needs to introduce crossover through via hole, which increases the resistance. In view of this, embodiments of the present disclosure propose a new layout structure.

Optionally, the reset circuit in the data providing circuit may include M reset transistors. M is equal to N−1; m is a positive integer less than or equal to M.

A gate electrode of the m-th reset transistor is electrically connected to the first multiplexing control terminal, a first electrode of the m-th reset transistor is electrically connected to the initial voltage line, and a second electrode of the m-th reset transistor is electrically connected to the (m+1)-th data line.

A first electrode of a reset transistor in M reset transistors is also used as a first electrode of another reset transistor in the M reset transistors.

In at least one embodiment of the present disclosure, the multiplexing circuit in the data providing circuit may include N multiplexing transistors.

A gate electrode of the n-th multiplexing transistor is electrically connected to the n-th multiplexing control terminal, a first electrode of the n-th multiplexing transistor is electrically connected to the data voltage providing terminal, and a second electrode of the n-th multiplexing transistor is electrically connected to the n-th data line.

The second electrode of the n-th multiplexing transistor is also used as a second electrode of an (n−1)-th reset transistor.

Optionally, N is equal to 3, and M is equal to 2.

A first electrode of a first reset transistor is also used as a first electrode of a second reset transistor.

The first electrode of the first reset transistor is also used as a second electrode of the second multiplexing transistor, and the second electrode of the second reset transistor is also used as a second electrode of a third multiplexing transistor.

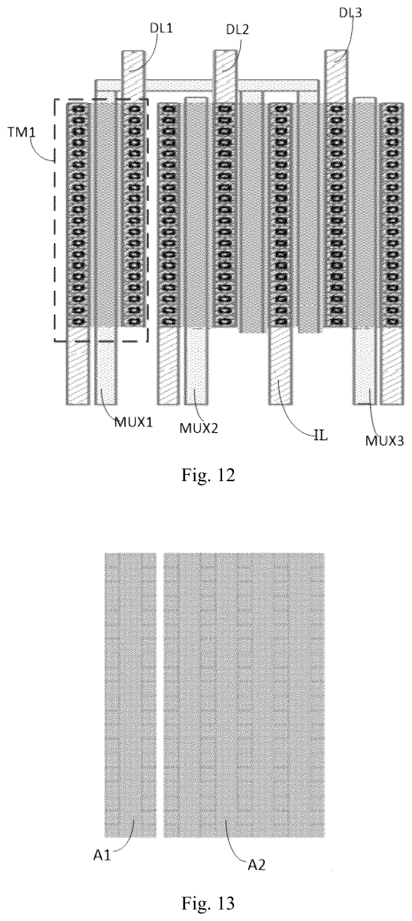

In FIG. 12, a case where N is equal to 3 and M is equal to 2 is taken as an example, and the data providing circuit includes a first multiplexing transistor TM1, a second multiplexing transistor TM2, a third multiplexing transistor TM3, a first reset transistor TR1, and a second reset transistor TR2.

As shown in FIGS. 12-15, TM1 is provided on the leftmost side.

A second electrode of TM2 is also used as a second electrode of TR1. An orthographic projection of the second column data line DL2 onto the base substrate at least partially overlaps with an orthographic projection of the second electrode of TM2 onto the base substrate.

A first electrode of TR1 is also used as a first electrode of TR2, the first electrode of TR1 and the first electrode of TR2 are both electrically connected to an initial voltage line IL, and an orthographic projection of the initial voltage line IL onto the base substrate at least partially overlaps with an orthographic projection of the first electrode of TR1 onto the base substrate.

A second electrode of TM3 is also used as a second electrode of TR2. An orthographic projection of the third column data line DL3 onto the base substrate at least partially overlaps with an orthographic projection of the second electrode of TM3 onto the base substrate.

In at least one embodiment of the layout diagram shown in FIG. 12, the channel width-length ratio of each transistor may be 100/5, the line width of the data line is at least 5 μm, and the spacing between the data lines is at least 3 μm.

The second electrode DM2 of TM2 is also used as the second electrode of TR1, the first electrode SR1 of TR1 is also used as the first electrode of TR2, the second electrode DM3 of TM3 is also used as the second electrode of TR2, and TR1 and TR2 share the initial voltage line IL so that reset can be achieved for the data providing circuit with only one initial voltage line IL, which also avoids the use of via crossover, and reduces the loading. The layout diagram shown in FIG. 12 has been calculated to reduce the layout area by 23.2% compared with the related layout.

In FIG. 12, reference sign DL1 denotes a first column data line, reference sign DL2 denotes a second column data line, and reference sign DL3 denotes a third column data line.

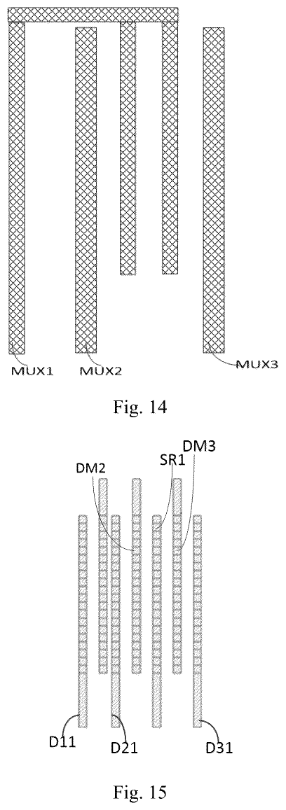

FIG. 13 is a layout diagram of a semiconductor layer in FIG. 12, FIG. 14 is a layout diagram of a gate metal layer in FIG. 12, and FIG. 15 is a layout diagram of a source-drain metal layer in FIG. 12.

In FIG. 13, reference sign A1 denotes a first active pattern, and reference sign A2 denotes a second active pattern.

In FIG. 15, reference sign D11 denotes the first one of first data voltage providing terminals, reference sign D21 denotes the second one of the first data voltage providing terminals, and reference sign D31 denotes the third one of the first data voltage providing terminal.

Optionally, N is equal to 5, and M is equal to 4.

A first electrode of a first reset transistor is also used as a first electrode of a second reset transistor, and a first electrode of a third reset transistor is also used as a first electrode of a fourth reset transistor.

The first electrode of the first reset transistor is also used as a second electrode of the second multiplexing transistor, and the second electrode of the second reset transistor is also used as a second electrode of the third multiplexing transistor. The first electrode of the third reset transistor is also used as a second electrode of the fourth multiplexing transistor, and the second electrode of the fourth reset transistor is also used as a second electrode of the fifth multiplexing transistor.

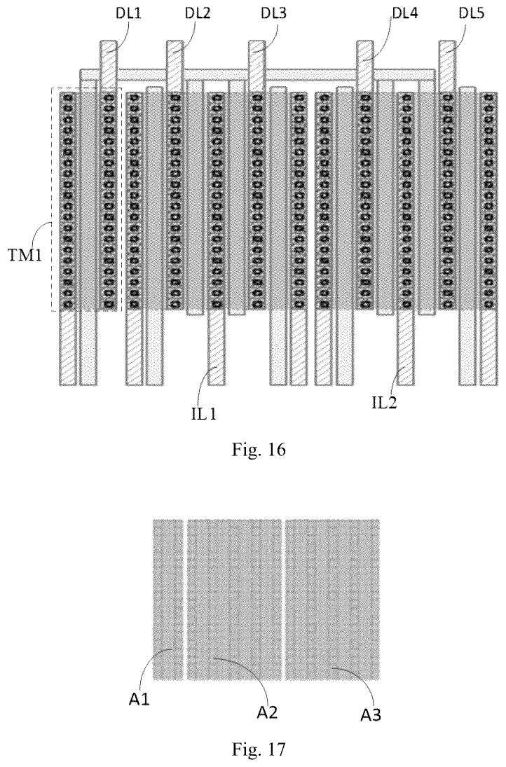

In FIG. 16, a case where N is equal to 5 and M is equal to 4 is taken as an example, and the data providing circuit includes a first multiplexing transistor TM1, a second multiplexing transistor TM2, a third multiplexing transistor TM3, a fifth multiplexing transistor TM4, a fifth multiplexing transistor TM5, a first reset transistor TR1, a second reset transistor TR2, and a third reset transistor TR3.

As shown in FIGS. 16-19, TM1 is provided on the leftmost side.

A second electrode DM2 of TM2 is also used as a second electrode of TR1. An orthographic projection of the second column data line DL2 onto the base substrate at least partially overlaps with an orthographic projection of the second electrode of TM2 onto the base substrate.

A first electrode SR1 of TR1 is also used as a first electrode of TR2, the first electrode of TR1 and the first electrode of TR2 are both electrically connected to a first initial voltage line IL1, and an orthographic projection of the first initial voltage line IL1 onto the base substrate at least partially overlaps with an orthographic projection of the first electrode of TR1 onto the base substrate.

A second electrode DM3 of TM3 is also used as a second electrode of TR2. An orthographic projection of the third column data line DL3 onto the base substrate at least partially overlaps with an orthographic projection of the second electrode of TM3 onto the base substrate.

A first electrode SR3 of TR3 is also used as a first electrode of TR4, the first electrode of TR1 and the first electrode of TR2 are both electrically connected to a second initial voltage line IL2, and an orthographic projection of the second initial voltage line IL2 onto the base substrate at least partially overlaps with an orthographic projection of the first electrode of TR3 onto the base substrate.

The second electrode of TR2 is also used as the second electrode of TM3.

The first electrode SR3 of TR3 is also used as the second electrode of TM4.

The second electrode DR4 of TR4 is also used as the second electrode of TM5.

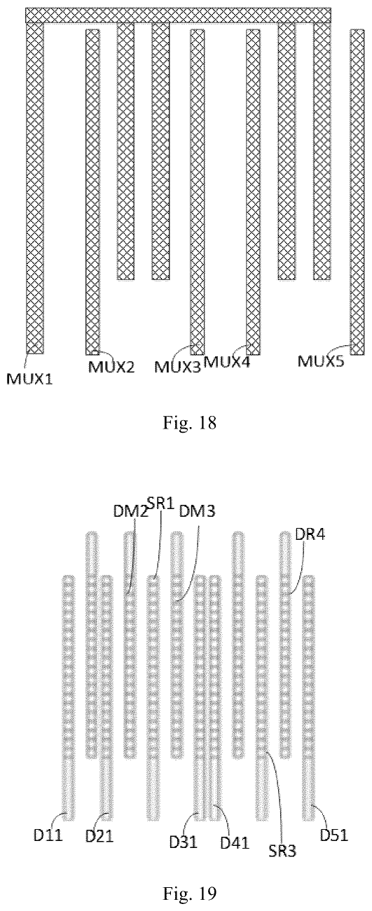

FIG. 17 is a layout diagram of a semiconductor layer in FIG. 16, FIG. 18 is a layout diagram of a gate metal layer in FIG. 16, and FIG. 19 is a layout diagram of a source-drain metal layer in FIG. 16.

In FIG. 17, reference sign Al denotes a first active pattern, reference sign A2 denotes a second active pattern, and reference sign A3 denotes a third active pattern.

In FIG. 19, reference sign D11 denotes the first one of first data voltage providing terminals, reference sign D21 denotes the second one of the first data voltage providing terminals, reference sign D31 denotes the third one of the first data voltage providing terminals, reference sign D41 denotes the fourth one of the first data voltage providing terminals, and reference sign D51 denotes the fifth one of the first data voltage providing terminals.

In FIG. 16, reference sign IL1 denotes a first initial voltage line, reference sign IL2 denotes a second initial voltage line, reference sign DL1 denotes a first column data line, reference sign DL2 denotes a second column data line, reference sign DL3 denotes a third column data line, reference sign DLA denotes a fourth column data line, and reference sign DL5 denotes a fifth data line.

In at least one embodiment of the layout diagram shown in FIG. 16, the channel width-length ratio of each transistor may be 100/5, the line width of the data line is at least 5 μm, and the spacing between the data lines is at least 3 μm.

The second electrode of TM2 is also used as the second electrode of TR1. The first electrode of TR1 is also used as the first electrode of TR2. The second electrode of TM3 is also used as the second electrode of TR2. The first electrode of TR3 is also used as the first electrode of TR4. The second electrode of TR2 is also used as the second electrode of TM3. The first electrode of the TR3 is also used as the second electrode of TM4. TR1 and TR2 share the first initial voltage line IL1 so that reset can be achieved for DL2 and DL3 with only one first initial voltage line IL1. TR3 and TR4 share the second initial voltage line so that reset can be achieved for DL4 and DL5 with only one second initial voltage line IL2, which also avoids the use of via crossover, and reduces the loading. The layout diagram shown in FIG. 16 has been calculated to have a reduced area compared with the related layout.

A display panel according to embodiments of the present disclosure includes the above-mentioned display substrate.

A display panel according to embodiments of the present disclosure includes the above-mentioned data providing circuit.

The display panel of at least one embodiment of the present disclosure further includes pixel circuits arranged in multiple rows and columns in a display region.

The pixel circuit includes a light-emitting element, a drive circuit (T3), and a writing control circuit (T2).

The drive circuit is configured to generate a drive current for driving the light-emitting element under control of a potential of a control terminal of the drive circuit.

The writing control circuit is electrically connected to a scanning line, the data line, and a first terminal of the drive circuit, and is configured to write a data voltage provided by the data line into the first terminal of the drive circuit under control of a scanning signal provided by the scanning line.

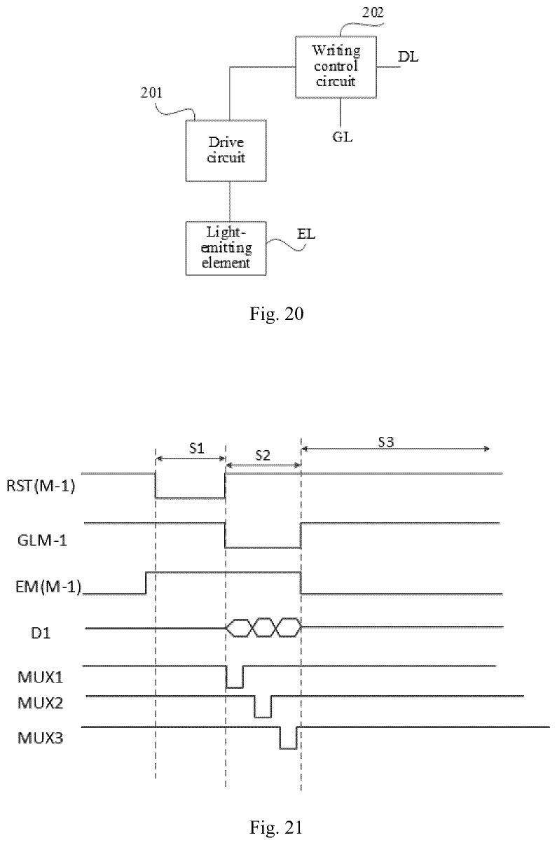

As shown in FIG. 20, the pixel circuit according to at least one embodiment may include a light-emitting element EL, a drive circuit 201, and a writing control circuit 202.

The drive circuit 201 is configured to control to generate a drive current for driving the light-emitting element EL under control of a potential of a control terminal of the drive circuit 201.

The writing control circuit 202 is electrically connected to a scanning line GL, a data line DL, and a first terminal of the drive circuit 201, and is configured to write a data voltage provided by the data line DL into the first terminal of the drive circuit 201 under control of a scanning signal provided by the scanning line GL.

A driving method according to embodiments of the present disclosure is applied to the above-mentioned display panel. A display cycle includes a data writing stage, and the data writing stage includes N writing time periods.

The driving method includes:
controlling, by the reset circuit, the initial voltage provided by the initial voltage line to be written into the data lines other than the first data line in the N data lines under control of the first multiplexing control signal, during a first writing time period; and
writing, by the multiplexing circuit, the data voltage provided by the data voltage providing terminal into the n-th data line under control of the n-th multiplexing control signal, during an n-th writing time period,
where N is an integer greater than 1, and n is a positive integer less than or equal to N.

In a specific implementation, the data writing stage may include N writing time periods. During the n-th writing time period, the multiplexing circuit writes the data provided by the data voltage providing terminal into the n-th data line, and during the first writing time period, the reset circuit controls the initial voltage provided by the initial voltage line to be written into the data lines other than the first data line in the N data lines under the control of the first multiplexing control signal.

Optionally, the display panel further includes pixel circuits arranged in multiple rows and columns in a display region; the pixel circuit includes a light-emitting element, a drive circuit, and a writing control circuit; the driving method further includes:
writing, by the writing control circuit, a data voltage provided by the data line into a first terminal of the drive circuit under control of a scanning signal, in the data writing stage.

In at least one embodiment of the present disclosure, the writing control circuit writes the data voltage on the data line into the first terminal of the drive circuit in the data writing stage.

Optionally, a start of the data writing stage coincides with a start of the first writing time period.

In at least one embodiment of the present disclosure, the display cycle further includes a pre-writing stage; the pre-writing stage is before the data writing stage, and the pre-writing stage is immediately adjacent to the data writing stage; the driving method includes: in the pre-writing stage, controlling, by the reset circuit, the initial voltage provided by the initial voltage line to be written into the data lines other than the first data line in the N data lines under control of the first multiplexing control signal, and writing, by the multiplexing circuit, the data voltage provided by the data voltage providing terminal into the first data line under control of the first multiplexing control signal.

In a specific implementation, the first multiplexing control terminal and the scanning line are simultaneously turned on, or the first multiplexing control terminal is turned on prior to the scanning line, so as to prevent the voltage signal remaining on the first data line in a previous display cycle from affecting the potential of the gate electrode of the drive transistor in the pixel circuit of the corresponding row of the first column.

As shown in FIG. 21, in operation of at least one embodiment shown in FIG. 7, reference sign S1 denotes a reset stage of an (M−1)-th row, reference sign S2 denotes a data writing stage of the (M−1)-th row, and reference sign S3 denotes a light-emitting stage of the (M−1)-th row.

The scanning line GLM-1 of the (M−1)-th row starts to provide a low voltage at the same time as the MUX1 starts to provide a low voltage.

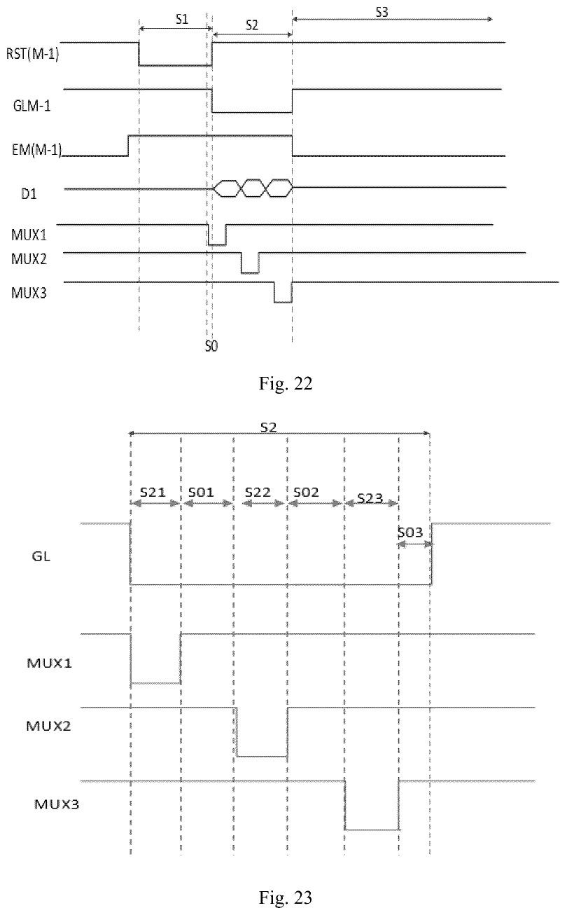

As shown in FIG. 22, in operation of at least one embodiment shown in FIG. 7, reference sign S1 denotes a reset stage of an (M−1)-th row, reference sign S2 denotes a data writing stage of the (M−1)-th row, and reference sign S3 denotes a light-emitting stage of the (M−1)-th row.

Before the scanning line GLM-1 of the (M−1)-th row starts to provide a low voltage, the MUX1 starts to provide a low voltage.

In FIG. 22, reference sign SO denotes a pre-writing stage.

As shown in FIG. 21, in operation of at least one embodiment shown in FIG. 7, in the reset stage S1 of the (M−1)-th row, RST (M−1) provides a low-voltage signal, T11, T17, T21, T27, T51, and T57 are turned on, and Vi resets the potential of the gate electrode of T13, the potential of the gate electrode of T23, the potential of the gate electrode of T53, the potential of the anode of O1, the potential of the gate electrode of O2, and the potential of the gate electrode of O5. In at least one embodiment of the present disclosure, Vi and Vint may be the same.

In the data writing stage S2 of the (M−1)-th row, GLM-1 provides a low-voltage signal, T12, T22, and T52 are turned on, and T15, T25, and T55 are turned on.

In the data writing stage S2 of (M−1)-th row, MUX1, MUX2, and MUX3 are turned on successively, i.e., S2 includes a first time period, a second time period, and a third time period which are set successively. During the first time period, MUX1 provides a low-voltage signal, and MUX2 and MUX3 provide high-voltage signals. During the second time period, MUX2 provides a low-voltage signal, and MUX1 and MUX3 provide high-voltage signals. During the third time period, MUX3 provides a low-voltage signal, and MUX1 and MUX2 provide high-voltage signals.

In the first time period, MUX1 provides a low-voltage signal, and TM1 is turned on. D1 provides a first data voltage to DL1, and provides a compensated first data voltage to the gate electrode of T13 through T12, T13, and T15. TR1 and TR2 are turned on, and DL2 and DL3 are reset through Vint.

In the second time period, MUX2 provides a low-voltage signal, and TM2 is turned on. D1 provides a second data voltage to DL2, and provides a compensated second data voltage to the gate electrode of T23 through T22, T23, and T25.

In the third time period, MUX3 provides a low-voltage signal, and TM3 is turned on. D1 provides a third data voltage to the DL3, and provides a compensated third data voltage to the gate electrode of T53 through T52, T53, and T55.

In the light-emitting stage S3 of the (M−1)-th row, EM (M−1) provides a low-voltage signal, and T14, T16, T24, T26, T54, and T56 are turned on. T13 drives O1 to emit light, T23 drives O2 to emit light, and T53 drives O5 to emit light.

In at least one embodiment of the present disclosure, N is not limited to being equal to 2, 3, or 5. In a specific implementation, N may be an integer greater than 1.

The driving method of at least one embodiment of the present disclosure further includes:
controlling the data voltage provided by the data voltage providing terminal to be Va+ΔVa during an a-th writing time period, where a is an integer less than or equal to N and greater than 1;
ΔVa is equal to (Va−Vth−V0)×(e^{-(t1-t0a)/RC})−e^{-(t1/RC)}),
where Vth is a threshold voltage of a drive transistor included in the drive circuit, and Va is a data voltage required to be written into an a-th data line during the a-th writing time period;
t1 is a duration of the data writing stage, and t0a is equal to (a−1)×(t2+t3),
where t2 is a duration of each writing time period, t3 is an interval time between two adjacent writing time periods, R is a resistance value of a resistor on the data line, C is a capacitance value of a coupling capacitor on the data line, and V0 is a voltage on the data lines after the reset circuit controls the initial voltage provided by the initial voltage line to be written into the data lines other than the first data line in the N data lines under control of the first multiplexing control signal.

As shown in FIG. 11, when performing simulation verification based on the verification simulation module in FIG. 10, the potential of g1, the potential of g2, and the potential of g3 may have a difference due to the fact that: during the period in which the scanning line is turned on, the coupling capacitor on DL1 is charged first, and g1 is charged constantly during the period in which DL2 writes the second data voltage and DL3 writes the third data voltage. Similarly, DL2 may also be charged constantly during the period in which DL3 writes the third data voltage, thus resulting in the potential of g1 greater than the potential of g2 and the potential of g2 greater than the potential of g3. Thus, at least one embodiment of the present disclosure provides the data voltage compensation method.

As shown in FIG. 23, reference sign S21 denotes a first writing time period, reference sign S22 denotes a second writing time period, and reference sign S23 denotes a third writing time period. Reference sign GL denotes a scanning line, reference sign MUX1 denotes a first multiplexing control terminal, reference sign MUX2 denotes a second multiplexing control terminal, and reference sign MUX3 denotes a third multiplexing control terminal.

Reference sign S01 denotes a first time interval, reference sign S02 denotes a second time interval, and reference sign S03 denotes a third time interval.

The duration of S2 is t1, the duration of S21, the duration of S22, and the duration of S23 are the same, all being t2. The duration of S01, the duration of S02, and the duration of S03 are the same, all being t3. Then, the compensation charging time of DL2 is t2+t3, and the compensation charging time of DL3 is 2t2+2t3. It is assumed that the voltage required to be written by DL2 is V2 when MUX2 is turned on, and the voltage required to be written by DL3 is V3 when MUX3 is turned on, then, the compensation voltage ΔV2 needed to be written by DL2 is approximately V0+(V2−Vth)−V0)−(1−e^{-(t1/RC)})−(V0+(V2−Vth−V0)×(1−e^{-((t1-t2-t3)/RC)})), i.e., ΔV2 is approximately (V2−Vth−V0)×(e^{-((t1-t2-t3)/RC)})−e^{-(t1/RC)}); the compensation voltage ΔV3 needed to be written by DL3 is approximately V0+(V2−Vth)−V0)×(1−e^{-(t1/RC)})−(V0+(V2−Vth−V0)×(1−e^{-((t1-t2-t3)/RC)})), i.e., ΔV3 is approximately (V2−Vth−V0)×(e^{-((t1-t2-t3)/RC)})−e^{-(t1/RC)}). Then finally, the voltage required to be actually written by DL2 is approximately V2+ΔV2, and the voltage required to be actually written by DL3 is approximately V3+ΔV3.

Vth is a threshold voltage of a drive transistor included in each drive circuit, R is a resistance value of a resistor on each data line, C is a capacitance value of a coupling capacitor on each data line, and V0 is a voltage on a corresponding data line after TR1 and TR2 writes the initial voltage Vint into the corresponding data line. V0 is approximately the same as Vint.

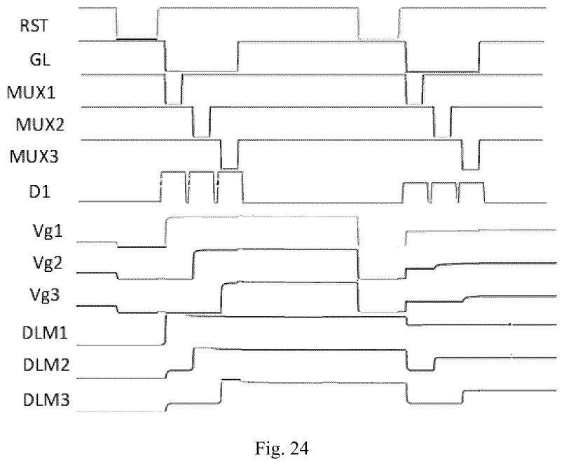

Through the above-mentioned compensation method, as shown in FIG. 24, when performing simulation verification based on the verification simulation module in FIG. 10, and in a case that a target data voltage is 3V, the potential of g1, the potential of g2, and the potential of g3 all reach about 2.53V.

A display device according to embodiments of the present disclosure includes the above-mentioned display panel.

The above descriptions are preferred embodiments of the present disclosure. It should be noted that those skilled in the art that can make various improvements and modifications without departing from the principle of the present disclosure, and the improvements and the modifications shall fall within the scope of protection of the present disclosure.

1. A data providing circuit, comprising a multiplexing circuit and a reset circuit, wherein N is an integer greater than 1;
wherein the multiplexing circuit is electrically connected to a data voltage providing terminal, N multiplexing control terminals, and N data lines, and is configured to write a data voltage provided by the data voltage providing terminal into an n-th data line under control of an n-th multiplexing control signal provided by an n-th multiplexing control terminal; n is a positive integer less than or equal to N;
wherein the reset circuit is electrically connected to a first multiplexing control terminal, an initial voltage line, and data lines other than a first data line in the N data lines, and is configured to control an initial voltage provided by the initial voltage line to be written into the data lines other than the first data line in the N data lines under control of a first multiplexing control signal provided by the first multiplexing control terminal.

2. The data providing circuit according to claim 1, wherein the reset circuit comprises M reset sub-circuits; M is equal to N−1; m is a positive integer less than or equal to M;
wherein a control terminal of an m-th reset sub-circuit is electrically connected to the first multiplexing control terminal, a first terminal of the m-th reset sub-circuit is electrically connected to the initial voltage line, and a second terminal of the m-th reset sub-circuit is electrically connected to an (m+1)-th data line;
wherein the m-th reset sub-circuit is configured to write the initial voltage provided by the initial voltage line into the (m+1)-th data line under control of the first multiplexing control signal provided by the first multiplexing control terminal.

3. The data providing circuit according to claim 1, wherein the multiplexing circuit comprises N multiplexing sub-circuits;
wherein a control terminal of an n-th multiplexing sub-circuit is electrically connected to the n-th multiplexing control terminal, a first terminal of the n-th multiplexing sub-circuit is electrically connected to the data voltage providing terminal, and a second terminal of the n-th multiplexing sub-circuit is electrically connected to the n-th data line;
wherein the n-th multiplexing sub-circuit is configured to write the data voltage provided by the data voltage providing terminal into the n-th data line under control of the n-th multiplexing control signal provided by the n-th multiplexing control terminal.

4. A display substrate, comprising a base and the data providing circuit according to claim 1 provided on the base.

5. The display substrate according to claim 4, wherein the reset circuit in the data providing circuit comprises M reset sub-circuits; M is equal to N−1; m is a positive integer less than or equal to M;
wherein a control terminal of an m-th reset sub-circuit is electrically connected to the first multiplexing control terminal, a first terminal of the m-th reset sub-circuit is electrically connected to the initial voltage line, and a second terminal of the m-th reset sub-circuit is electrically connected to an (m+1)-th data line; wherein the m-th reset sub-circuit is configured to write the initial voltage provided by the initial voltage line into the (m+1)-th data line under control of the first multiplexing control signal provided by the first multiplexing control terminal;
wherein a first terminal of a reset sub-circuit in the M reset sub-circuits is further used as a first terminal of another reset sub-circuit in the M reset sub-circuits.

6. The display substrate according to claim 5, wherein the multiplexing circuit in the data providing circuit comprises N multiplexing sub-circuits;
wherein a control terminal of an n-th multiplexing sub-circuit is electrically connected to the n-th multiplexing control terminal, a first terminal of the n-th multiplexing sub-circuit is electrically connected to the data voltage providing terminal, and a second terminal of the n-th multiplexing sub-circuit is electrically connected to the n-th data line; wherein the n-th multiplexing sub-circuit is configured to write the data voltage provided by the data voltage providing terminal into the n-th data line under control of the n-th multiplexing control signal provided by the n-th multiplexing control terminal;
wherein the second terminal of the n-th multiplexing sub-circuit is further used as a second terminal of an (n−1)-th reset sub-circuit.

7. The display substrate according to claim 6, wherein the m-th reset sub-circuit comprises an m-th reset transistor;
wherein a gate electrode of the m-th reset transistor is electrically connected to the first multiplexing control terminal, a first electrode of the m-th reset transistor is electrically connected to the initial voltage line, and a second electrode of the m-th reset transistor is electrically connected to the (m+1)-th data line;
wherein a first electrode of a reset transistor in M reset transistors is further used as a first electrode of another reset transistor in the M reset transistors.

8. The display substrate according to claim 7, wherein the n-th multiplexing sub-circuit comprises an n-th multiplexing transistor;
wherein a gate electrode of the n-th multiplexing transistor is electrically connected to the n-th multiplexing control terminal, a first electrode of the n-th multiplexing transistor is electrically connected to the data voltage providing terminal, and a second electrode of the n-th multiplexing transistor is electrically connected to the n-th data line;
wherein the second electrode of the n-th multiplexing transistor is further used as a second electrode of an (n−1)-th reset transistor.

9. The display substrate according to claim 8, wherein N is equal to 3, and M is equal to 2;
wherein a first electrode of a first reset transistor is further used as a first electrode of a second reset transistor;
wherein the first electrode of the first reset transistor is further used as a second electrode of a second multiplexing transistor, and a second electrode of the second reset transistor is further used as a second electrode of a third multiplexing transistor.

10. The display substrate according to claim 8, wherein N is equal to 5, and M is equal to 4;
wherein a first electrode of a first reset transistor is further used as a first electrode of a second reset transistor, and a first electrode of a third reset transistor is further used as a first electrode of a fourth reset transistor;
wherein the first electrode of the first reset transistor is further used as a second electrode of a second multiplexing transistor, and a second electrode of the second reset transistor is further used as a second electrode of a third multiplexing transistor; the first electrode of the third reset transistor is further used as a second electrode of a fourth multiplexing transistor, and a second electrode of the fourth reset transistor is further used as a second electrode of a fifth multiplexing transistor.

11. A display panel, comprising the display substrate according to claim 4.

12. A display panel, comprising the data providing circuit according to claim 1.

13. The display panel according to claim 12, further comprising pixel circuits arranged in a plurality of rows and columns in a display region;
wherein the pixel circuit comprises a light-emitting element, a drive circuit, and a writing control circuit;
wherein the drive circuit is configured to generate a drive current for driving the light-emitting element under control of a potential of a control terminal of the drive circuit;
wherein the writing control circuit is electrically connected to a scanning line, the data line, and a first terminal of the drive circuit, and is configured to write a data voltage provided by the data line into the first terminal of the drive circuit under control of a scanning signal provided by the scanning line.

14. A driving method, applied to the display panel according to claim 12, wherein a display cycle comprises a data writing stage, and the data writing stage comprises N writing time periods;
wherein the driving method comprises:
controlling, by the reset circuit, the initial voltage provided by the initial voltage line to be written into the data lines other than the first data line in the N data lines under control of the first multiplexing control signal, during a first writing time period; and
writing, by the multiplexing circuit, the data voltage provided by the data voltage providing terminal into the n-th data line under control of the n-th multiplexing control signal, during an n-th writing time period;
wherein N is an integer greater than 1, and n is a positive integer less than or equal to N.

15. The driving method according to claim 14, wherein the display panel further comprises pixel circuits arranged in a plurality of rows and columns in a display region; the pixel circuit comprises a light-emitting element, a drive circuit, and a writing control circuit; the driving method further comprises:
writing, by the writing control circuit, a data voltage provided by the data line into a first terminal of the drive circuit under control of a scanning signal, in the data writing stage.

16. The driving method according to claim 15, wherein a start of the data writing stage coincides with a start of the first writing time period.

17. The driving method according to claim 15, wherein the display cycle further comprises a pre-writing stage; the pre-writing stage is before the data writing stage, and the pre-writing stage is immediately adjacent to the data writing stage; the driving method comprises:
in the pre-writing stage, controlling, by the reset circuit, the initial voltage provided by the initial voltage line to be written into the data lines other than the first data line in the N data lines under control of the first multiplexing control signal, and writing, by the multiplexing circuit, the data voltage provided by the data voltage providing terminal into the first data line under control of the first multiplexing control signal.

18. The driving method according to claim 15, further comprising:
controlling the data voltage provided by the data voltage providing terminal to be Va+ΔVa during an a-th writing time period, where a is an integer less than or equal to N and greater than 1;
wherein ΔVa is equal to (Va−Vth−V0)×(e^{-(t1-t0a)/RC})−e^{-(t1/RC)}),
wherein Vth is a threshold voltage of a drive transistor comprised in the drive circuit, and Va is a data voltage required to be written into an a-th data line during the a-th writing time period;
wherein t1 is a duration of the data writing stage, and t0a is equal to (a−1)×(t2+t3),
wherein t2 is a duration of each writing time period, t3 is an interval time between two adjacent writing time periods, R is a resistance value of a resistor on the data line, C is a capacitance value of a coupling capacitor on the data line, and V0 is a voltage on the data lines after the reset circuit controls the initial voltage provided by the initial voltage line to be written into the data lines other than the first data line in the N data lines under control of the first multiplexing control signal.

19. A display device, comprising the display panel according to claim 11.

20. A driving method, applied to the display panel according to claim 13, wherein a display cycle comprises a data writing stage, and the data writing stage comprises N writing time periods;
wherein the driving method comprises:
controlling, by the reset circuit, the initial voltage provided by the initial voltage line to be written into the data lines other than the first data line in the N data lines under control of the first multiplexing control signal, during a first writing time period; and
writing, by the multiplexing circuit, the data voltage provided by the data voltage providing terminal into the n-th data line under control of the n-th multiplexing control signal, during an n-th writing time period;
wherein N is an integer greater than 1, and n is a positive integer less than or equal to N.
